(19) United States
(12) Patent Application Publication
(10) Pub. No.: US 2009/0143061 A1
(43) Pub. Date: Jun. 4, 2009

(54) METHOD AND APPARATUS FOR THE REMOTE EXECUTION OF METHODS AND OBJECTS ON HANDSETS

(76) Inventors: Troy Wu, San Mateo, CA (US); James Kung, Foster City, CA (US); Jonathan Herriott, San Jose, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/327,765

(22) Filed: Dec. 3, 2008

Related U.S. Application Data
(60) Provisional application No. 60/992,022, filed on Dec. 3, 2007.

(51) Int. Cl. H04M 3/00

(52) U.S. Cl. 455/419

(57) ABSTRACT

A handset includes a set of executable instructions associated with an application programming interface (API) as well as a REMO client. Responsive to an indication of a particular application to be executed, the REMO client establishes a communication session over a network connection with a REMO server, on which the requested application is stored. The REMO server remotely invokes a series of API instructions on the handset via the REMO client. Accordingly, the REMO application resides on the REMO server, but can be executed (by way of the REMO client) on the handset without the need for verifying, signing, and downloading a separate application.

### RELATED APPLICATIONS

This is a NONPROVISIONAL of and claims priority to U.S. Provisional Patent Application 60/992,022, filed 3 Dec. 2007, incorporated herein by reference.

### FIELD OF THE INVENTION

The invention generally relates to the deployment of software applications on mobile devices. More specifically, the invention relates to a method and apparatus for remotely invoking API-related instructions (e.g., functions, methods and/or objects) to execute on mobile handsets.

### BACKGROUND

A variety of hurdles must be overcome to deploy software applications to mobile handsets. First, a wide variety of handsets with varying hardware and software specifications exist. Therefore, when developing a software application, a developer must either customize or tailor the software application to work with a particular handset, or alternatively, the developer must design the software application to work with a specified, common set of resources (e.g., hardware configuration, and software application programming interfaces (APIs)) available to a group of handsets. To better ensure that software applications will work with a particular handset or device, developers have created minimum standard requirements that, when present on a particular handset, ensure the operation of applications written to conform to those requirements.

For instance, one common set of minimum requirements is referred to as Java ME™ (Java Platform, Micro Edition), previously referred to as J2ME™ (Java 2 Platform, Micro Edition). In computing, the Java ME is a specification of a subset of the Java™ platform aimed at providing a certified collection of Java APIs for the development of software for small, resource-constrained devices such as mobile handsets, personal digital assistants (PDAs) and set-top boxes. Accordingly, software applications written to comply with the Java ME platform are likely to work with those devices that implement the Java ME platform.

Unfortunately, even when developing software applications for a common platform (such as Java ME), there are time consuming obstacles in the way of deploying software applications to handsets. For example, after an application has been developed, it generally must be packaged—that is, formatted and/or configured in a way that allows it to be communicated to a handset, and installed by an installation application executing on the handset. Often the way the application is packaged depends on the particular network and mobile operator on which the handset is configured to operate.

Furthermore, software applications often must be digitally signed so that the source of the application can be verified by the handset prior to the handset executing the application. Moreover, most mobile operators require that an application be verified prior to deployment. Verification involves determining that the software application conforms to the standard minimum set of requirements and properly utilizes network resources.

Finally, the application must be communicated over the network to the handset on which it will be installed. Generally this requires a user to take some action to initiate the download, which may not be intuitive for the user. Many network subscribers may be hesitant to download and install an application given the costs associated with utilizing the data network. Thus, there are many obstacles to deploying software applications to mobile handsets using existing solutions therefore.

### SUMMARY OF THE INVENTION

According to various embodiments of the invention, apparatus and methods for remotely executing an application on a handset make use of a special client, referred to herein as a “REMO” (remote execution of methods and objects) client, on the handset. The REMO client receives (e.g., from a user) an indication of a particular application to be executed and, responsive thereto, establishes a communication session over a network connection with a REMO server on which the requested application is stored. The REMO server then remotely invokes a series of API instructions on the handset via the REMO client. Thus, although the REMO application resides on the REMO server, it executes (by way of the REMO client) on the handset without the need for verifying, signing, and downloading a separate application to the handset.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings.

FIG. 1 is a logical block diagram showing an example handset with a REMO client communicatively coupled via a network to a REMO server, according to an embodiment of the invention;

FIG. 2 illustrates an example REMO application, according to an embodiment of the invention;

FIGS. 3 and 4 illustrate the process by which a REMO application is invoked by the REMO client over the network, according to an embodiment of the invention; and

FIG. 5 illustrates an example of a method for executing a REMO application, according to an embodiment of the invention.

### DETAILED DESCRIPTION

Described herein are methods and systems for the deployment of software applications to mobile devices. More specifically, the present invention relates to methods and apparatus for remotely invoking API-related instructions (e.g., functions, methods and/or objects) to execute on mobile handsets. Stated differently, the invention provides apparatus and methods for remotely executing an application on a handset.

As the term is used herein, a handset is generally understood to include a set of executable instructions (e.g., functions, methods and/or objects) associated with an application programming interface (API). Consistent with an embodiment of the invention, a special client on the handset, referred to herein as a “REMO” (remote execution of methods and objects) client, receives (e.g., from a user) an indication of a particular application to be executed. Upon receiving this indication, the REMO client establishes a communication session over a network connection with a REMO server, on which the requested application is stored. At the REMO server, the subject REMO application remotely invokes a series of API instructions on the handset via the REMO client stored thereon. Accordingly, although the REMO application resides on the REMO server, it can be executed (by way of the REMO client) on the handset without the need for verifying, signing, and downloading a separate application to the handset.

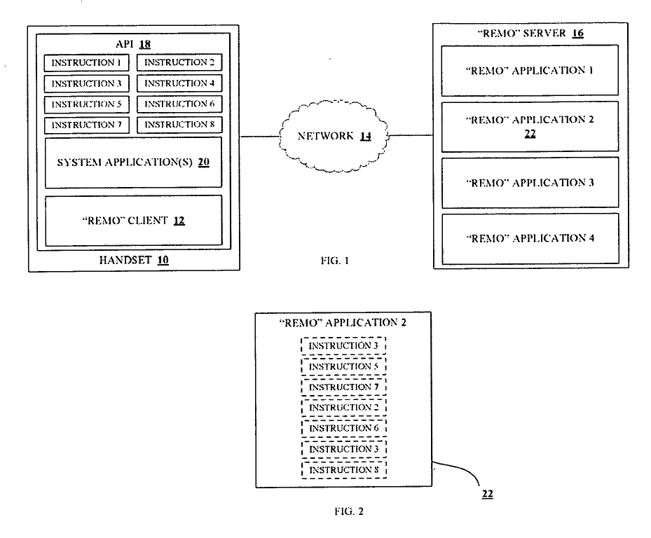

FIG. 1 is a logical block diagram showing an example handset 10 with a REMO client 12. The handset (and the REMO client) is (are) communicatively coupled via a network 14 to a REMO server 16. As illustrated in FIG. 1, the handset 10 includes an application programming interface (API) 18. An application programming interface (API) is a software interface that a computer application, operating system or library provides to support requests for services to be made of it by another software application. For instance, the API illustrated in FIG. 1 provides a common, documented or publicly available interface for invoking the various instructions (e.g., instruction 1, instruction 2, and so on) implemented on the handset 10. Although illustrated in FIG. 1 as instructions, it will be appreciated by those skilled in the art that the instructions invoked via the API may in fact be functions, methods, objects, or any other modular unit of computer-readable instructions (e.g., software or code) used in computer programming. Furthermore, the API may be any of a number of conventional and publicly available APIs, or a proprietary API For example, in one embodiment of the invention, the handset may support an API related to the Java ME (or J2ME) framework, including one or more of CLDC (connected limited device configuration), MIDP (mobile information device profile), and/or JSR-75 (an optional PDA package for the J2ME platform).

In addition to the various instructions illustrated in FIG. 1 as part of the API, system applications 20 and a REMO client application 12 are illustrated. The system applications 20 are simply a collection of various API-related instructions organized to perform particular system functions. For instance, one system application may provide an address book by which various contact information may be entered into memory of the handset, and displayed on a display device of the handset. Other system applications may provide system functions such as establishing and managing data and/or voice communication sessions over the network 14 or another network. Another example of a system application includes a call history log.

The REMO client 12 is a special application used to invoke a REMO application stored on the remote REMO server 16. Like the various system applications 20, the REMO client 12 is an application written in a language consistent with the collection of API-related instructions supported by the handset. For instance, in one embodiment of the invention, the REMO client 12 is an application written for the Java ME platform.

It will be appreciated by those skilled in the art that the handset 10 illustrated in FIG. 1 may include logic and/or a number of functional components which, to avoid obscuring the invention, have not been illustrated in detail. For instance, in general, the handset may include a display device (e.g., liquid crystal display (LCD)), a central processing unit and one or more communications chips for sending and receiving voice and data over a network.

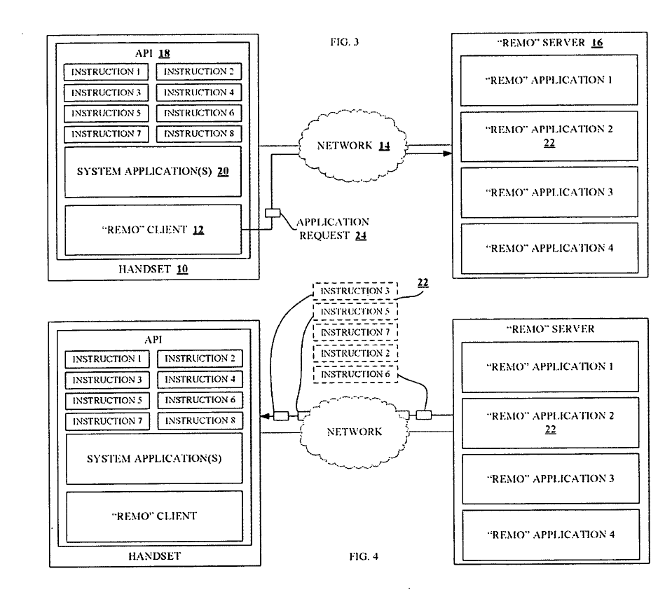

FIG. 2 illustrates an example REMO application 22, according to an embodiment of the invention. As illustrated in FIG. 2, a REMO application is a collection of instructions used to invoke API-related instructions on the handset. The instructions comprising the REMO application 22 are not the same as the instructions on the handset, but instead, the instructions comprising the REMO application 22 are used to invoke the API-related instructions on the handset. Accordingly, the instructions illustrated in FIG. 2 are shown with a dotted outline to distinguish them from their counterparts, which reside on the handset.

FIGS. 3 and 4 illustrate the process by which a REMO application 22 is invoked by the REMO client 12 over the network 14, according to an embodiment of the invention. First, the REMO client 12 establishes a communication session over the network with the REMO server 16. Next, as illustrated in FIG. 3, a REMO application is invoked when the REMO client communicates an application request 24 from the handset to the REMO server 16. The application request may be communicated, for example, in response to a user selecting a particular REMO application to be invoked. In one embodiment of the invention, the REMO client 12 causes the available REMO applications to be displayed on the handset display, thereby enabling a user to select from the available REMO applications. Advantageously, the REMO client 12 will automatically update and display the listing of available applications as new applications are added to the REMO server 16. This eliminates the need to download new applications to the handset. From the user's perspective, a REMO application appears as if it is residing and executing on the handset.

As illustrated in FIG. 4, once the REMO client 12 has communicated an application request to the REMO server 16, the REMO server 16 begins communicating instructions to the REMO client 12, causing the REMO client 12, in turn, to invoke API-related instructions (e.g., functions, methods, and/or objects) on the handset. Accordingly, the REMO application 22 executes in the context of both the REMO client 12 and the REMO server 18.

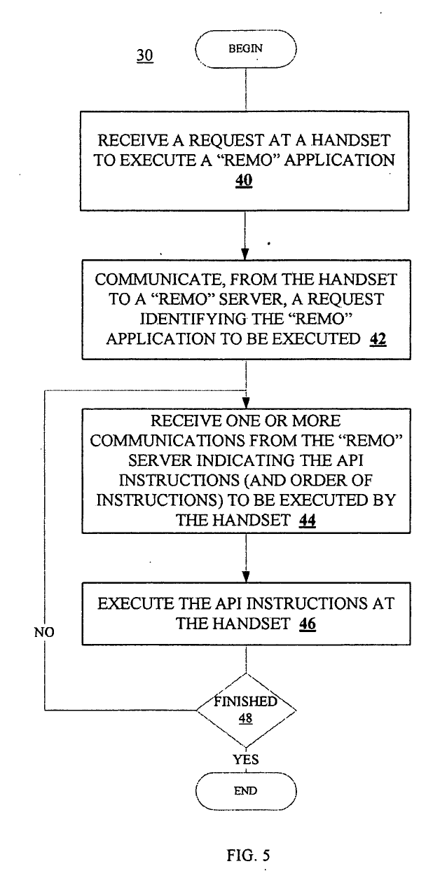

FIG. 5 illustrates an example of a method 30 for executing a REMO application, according to an embodiment of the invention. At operation 40, a request is received at the handset to execute a particular REMO application For instance, the request may be received as a result of a user manipulating the buttons, or other user interface objects, on the handset. In any case, at operation 42, an application request is communicated from the REMO client (on the handset) to the REMO server, where the REMO application is stored. Next, at operation 44, an instruction is communicated to the REMO client to invoke various API-related instructions on the handset, for example, functions, methods, and/or objects. Finally, at operation 46, the various API-related instructions are executed. Operations 44 through 46 are repeated (48) until such time as the execution of the REMO application is complete, or a user terminates execution of the application. Note, by simultaneously executing two instances of the REMO client application, a user can execute two REMO applications at the same time.

The foregoing description of various implementations of the invention has been presented for purposes of illustration and description. It is not exhaustive and does not limit the invention to the precise form or forms disclosed. Furthermore, it will be appreciated by those skilled in the art that the present invention may find practical application in a variety of alternative contexts that have not explicitly been addressed herein. Finally, the illustrative processing steps performed by a computer-implemented program may be executed simultaneously, or in a different order than described above, and additional processing steps may be incorporated. The invention may be implemented in hardware, software, or a combination thereof. When implemented partly in software, the invention may be embodied as instructions stored on a computer- or machine-readable medium.

What is claimed is:

1. A method, comprising:
responsive to an indication of a particular application to be executed at a mobile handset, said handset including a set of executable instructions associated with an application programming interface (API), establishing a communication session over a network connection between the handset and a server on which the requested application is stored; and
remotely invoking, by the server, a series of API instructions on the handset.

2. The method of claim 1, wherein the communication session is established between an application executing at the handset and the server.

3. The method of claim 1, wherein the handset API is a Java ME API.

4. The method of claim 1, wherein the requested application comprises instructions used to invoke the API-related instructions on the handset.

5. A method, comprising establishing a communication session over a network between a first application executing on a mobile handset and a second application executing on a server, the second application comprising instructions used to invoke API-related instructions on the mobile handset; communicating instructions from the second application to the first application; and the first application invoking the API-related instructions on the mobile handset.

6. The method of claim 5, wherein the communication session is established in response to a user selecting the second application to be invoked.

7. The method of claim 6, wherein an indication of availability of the second application is displayed on a display of the mobile handset.

8. A system, comprising:
a mobile handset having a set of executable instructions associated with an application programming interface (API) and a first application;
a server having a second application, the second application comprising instructions used to invoke the API-associated instructions on the mobile handset; and
a network communicatively coupling the first application at the mobile handset with the second application at the server.

9. A method, comprising receiving, at a handset, a request to execute an application stored at a server; communicating the request from a client on the handset to the server; communicating an instruction from the server to the client on the handset to invoke application programming interface (API)-related instructions on the handset; and executing, on the handset, the API-related instructions.

10. The method of claim 9, wherein the request is received as a result of a user manipulating user interface objects on the handset.
